(19) United States
(12) Patent Application Publication
(10) Pub. No.: US 2011/0023036 A1
(43) Pub. Date: Jan. 27, 2011

(54) SWITCHING PROCESS TYPES IN A PROCESS ENGINE

(75) Inventors: ANDREW D. HUMPHREYS, EMSWORTH (GB); CARLO MARCOLI, HEATHSIDE CRESCENT (GB)

Correspondence Address: LAW OFFICE OF JIM BOICE, 3839 BEE CAVE ROAD, SUITE 201, WEST LAKE HILLS, TX, 78746, US

(73) Assignee: INTERNATIONAL BUSINESS MACHINES CORPORATION, ARMONK, NY (US)

(21) Appl. No.: 12/839,493

(22) Filed: Jul. 20, 2010

(30) Foreign Application Priority Data
Jul. 24, 2009 (EP) 09166307.0

(51) Int. Cl. G06F 9/48

(52) U.S. Cl. 718/100

(57) ABSTRACT

A method and system are provided for switching process types in a process engine. The system includes a process engine for running a process, wherein the process includes invoking one or more external services. An event manager is provided having one or more defined policies and including: a comparison component for comparing runtime metrics of the process with the one or more defined policies and determining if the process infringes one or more defined policies; and a switching component for switching the process from an uninterruptible process to a long running process including copying state information on the process from in-memory storage to persistent storage. The system also includes a storage mechanism that acts as a storage façade to ensure the copying of state information on the process from in-memory storage to persistent storage is transparent to the process engine and a connection manager through which exchanges with clients and external services takes place.

### CROSS-REFERENCE TO RELATED APPLICATIONS

Pursuant to 35 U.S.C. 119, Applicant claims a right of priority to EP Patent Application No. 09166307.0 filed 24 Jul. 2009.

### BACKGROUND

This invention pertains to computers and other data processing systems and software and, more particularly, to managing processes in process engines and the switching of process types in a process engine.

Process engines, such as Java Enterprise Edition based business process engines (Java is a trademark of Sun Microsystems, Inc.), run business processes that interact through web services operations. Process engines support two types of processes: uninterruptible and long running.

Uninterruptible processes are expected to have a short lifespan; they orchestrate calls to synchronous services and return a result to the client in a few seconds. They offer high performance and consume limited resources; however, they cannot handle interactions over a long period of time.

Long running processes orchestrate activities that can take hours, days or weeks. They typically communicate with external services asynchronously through a messaging middleware and store state in a database. Long running processes have slow response times and high resource consumption.

It is common industry practice to create processes that orchestrate loosely coupled services where service providers are not controlled by the process owner. For this reason service performance and reliability can be very difficult to predict. For example, a web service exposed through the Internet can generally respond in fractions of seconds but on some occasions could take minutes depending on the amount of web traffic.

Currently the choice of implementing a long running process versus an uninterruptible process is made at development time. This causes unnecessary overheads when a service response time is unreliable. For example, if a service is expected to respond quickly 99% of the time, but for 1% of the time will not respond for minutes, the developer is forced to build and deploy a long running process to support the 1% of calls that are slow and must incur the overhead of a long running process in the 99% of instances that could have been implemented in an uninterruptible process.

### SUMMARY

According to a first aspect of the present invention there is provided a computer-implemented method for switching process types in a process engine, comprising: running a process in a process engine, wherein the process includes invoking one or more external services; comparing the runtime metrics of the process with one or more defined policies; determining if the process infringes one or more defined policies; and issuing a switching command to switch the process from an uninterruptible process to a long running process including copying state information on the process from in-memory storage to persistent storage.

According to a second aspect of the present invention there is provided a system for switching process types in a process engine, comprising: a process engine for running a process, wherein the process includes invoking one or more external services; an event manager having one or more defined policies and including: a comparison component for comparing runtime metrics of the process with the one or more defined policies and determining if the process infringes one or more defined policies; and a switching component for switching the process from an uninterruptible process to a long running process including copying state information on the process from in-memory storage to persistent storage.

According to a third aspect of the present invention there is provided a computer program product for switching process types in a process engine, the computer program product comprising: a computer readable medium; computer program instructions operative to: run a process in a process engine, wherein the process includes invoking one or more external services; compare runtime metrics of the process with one or more defined policies; determine if the process infringes one or more defined policies; and issue a switching command to switch the process from an uninterruptible process to a long running process including copying state information on the process from in-memory storage to persistent storage; wherein the program instructions are stored on the computer readable medium.

This disclosure describes a mechanism for dynamically managing processes in a process engine so that they can be switched between “uninterruptible” and “long running” depending on the runtime conditions encountered when invoking external services.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with the present invention;

FIG. 2 is a block diagram of a computer system in which the present invention may be implemented;

FIG. 3 is a flow diagram of a method in accordance with the present invention; and

FIG. 4 is an activity diagram of a method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method and system are described in which a process engine is modified so that a process instance is not classified as either “long running” or “uninterruptible” at development time. Instead, the process engine at runtime switches between the types according to policies based on runtime metrics. This maximizes performances and computing efficiency.

A policy can, for example, specify that the process will switch from “uninterruptible” to “long running” when the response time of a service exceeds a predefined value. In another scenario, the switch could be triggered by the overall process duration, or by the execution of a conditional process path.

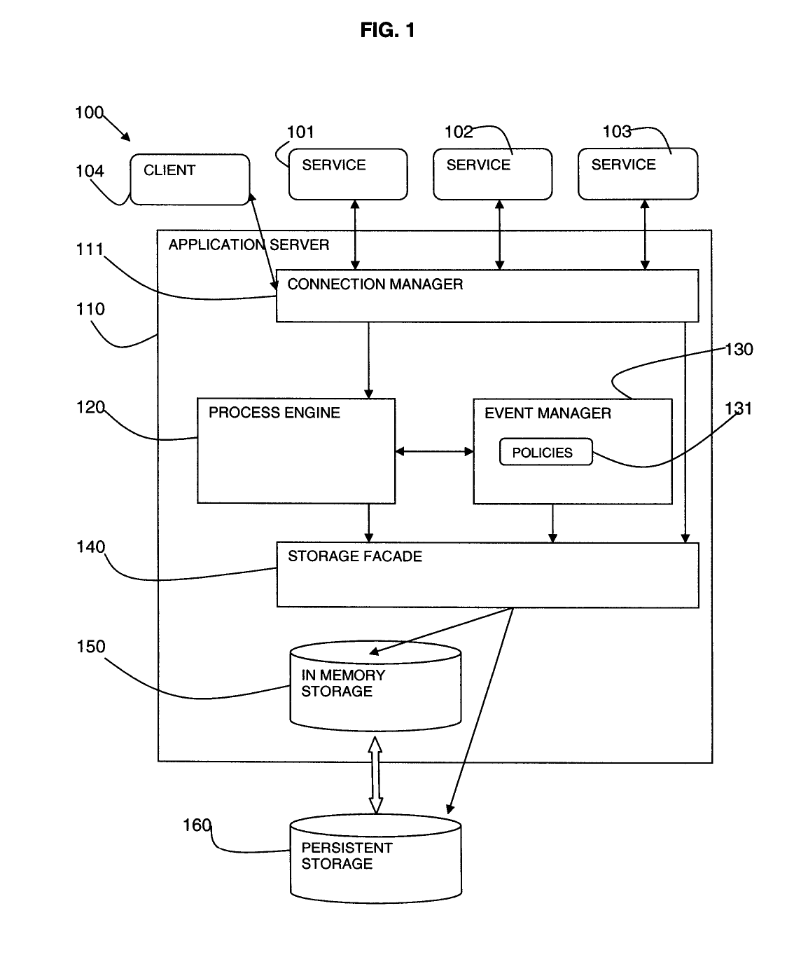

Referring to FIG. 1, a block diagram shows the described system 100. The system 100 includes an application server 110 with a connection manager 111 such as a service integration bus, which exchanges data with clients 101 and services 102-104.

A process engine 120 is provided on the application server 110 and the process engine 120 controls process execution. An event manager 130 also runs on the application server 110.

Both the connection manager 111 and the process engine 120 keep state information in storage such as datastores, which may be in-memory 150 or persistent 160. An “in-memory” storage 150 runs on the server 110. A “persistent” storage 160 may be in the form of a relational database.

In-memory storage may be in the form of random access memory (RAM) or other forms of fast but temporary storage. In-memory storage may be referred to as primary storage or memory. Persistent storage may be in the form of storage of a more permanent nature, which may also be referred to as secondary storage. Persistent storage may include mass storage such as optical disks, magnetic storage such as hard drives, online storage, and other types of permanent storage.

A storage mechanism is provided including a storage façade 140, in-memory storage 150, and persistent storage 160. Moving data from the in-memory storage 150 to the persistent storage 160 is transparent to the process engine 120 and the connection manager 111. Both the process engine 120 and the connection manager 111 are therefore connected to the storage façade 140 and not directly to the in-memory 150 or persistent storage 160. The storage façade 140 hides from the process engine 120 and the connection manager 111 whether the process state is held in persistent storage 160 or in-memory storage 150.

The event manager 130 has defined runtime polices 131 based on runtime metrics. A policy can dictate that a process switches from “uninterruptible” to “long running”, and the process state will be moved between the in-memory storage 150 and the persistent storage 160 when the event manager 130 issues a command. The event manager 130 compares runtime metrics with the defined policies 131 and determines if a policy 131 is infringed, and issues a switching command to a storage façade 140. The event manager 130 can be considered to have a comparison component that checks to see if a policy has been broken, and a switching component that switches the state.

A storage façade 140 is provided as a common entry point to the in-memory storage 150 and the persistent storage 160, and is responsible for coordinating the copying of data from the in-memory storage 150 and the persistent storage 160. The difference between the two types of storage 150 and 160 is transparent to its users (the process engine 120 and the connection manager 111) due to the façade 140.

When a client 101 and services 102-104 interact with the connection manager 111, the connection manager 111 routes requests and responses through to the process engine 120. The connection manager 111 has access to the storage façade 140, which can use both in-memory 150 and persistent 160 storage, and that can seamlessly move between the two types of storage. The storage 150 and 160 holds the state of the process.

If all the services 102-104 respond quickly, the process can complete and return a result to the client 101 without writing any data in the persistent storage 160. This assures high performance and efficient resource utilization.

In the case in which one or more services 102-104 are slow to respond, the event manager 130 reaches a timeout or other infringement of the defined policies 131 and issues a command to the in-memory storage 150 via the storage façade 140. States are copied from the in-memory storage 150 (such as from Hash Tables) to database tables in the persistent storage 160. This operation is transparent to the connection manager 111 and process engine 120 as they access the storage through the façade 140. Once the data is in persistent storage 160, threads can be released and used to serve other requests.

In one embodiment, the application server 110 is a Java Enterprise Edition application server, and the process engine 120 is built on a Java Enterprise Edition based business process engine. The event manager 130 is built in Java and runs on the Java Enterprise Edition application server 110. The in-memory storage 150 is a Java Hashmap running on the Java Enterprise Edition application server 110. The persistent storage 160 is provided by a DB2 relational database (DB2 is a trademark of International Business Machines Corporation). The storage façade 140 is implemented by a Java component, such as an Enterprise Session Bean.

A process engine 120 is modified so that it can use the storage façade 140 API whenever it needs to manage a state. A process engine 120 will usually store messages in a relational database 160. In the described process engine 120, messages are stored using storage façade 140. The event manager 130 controls the nature of the persistence mechanism used behind the façade 140 and it can issue a command that makes the façade 140 copy a set of data from the in-memory storage 150 to the persistent storage 160.

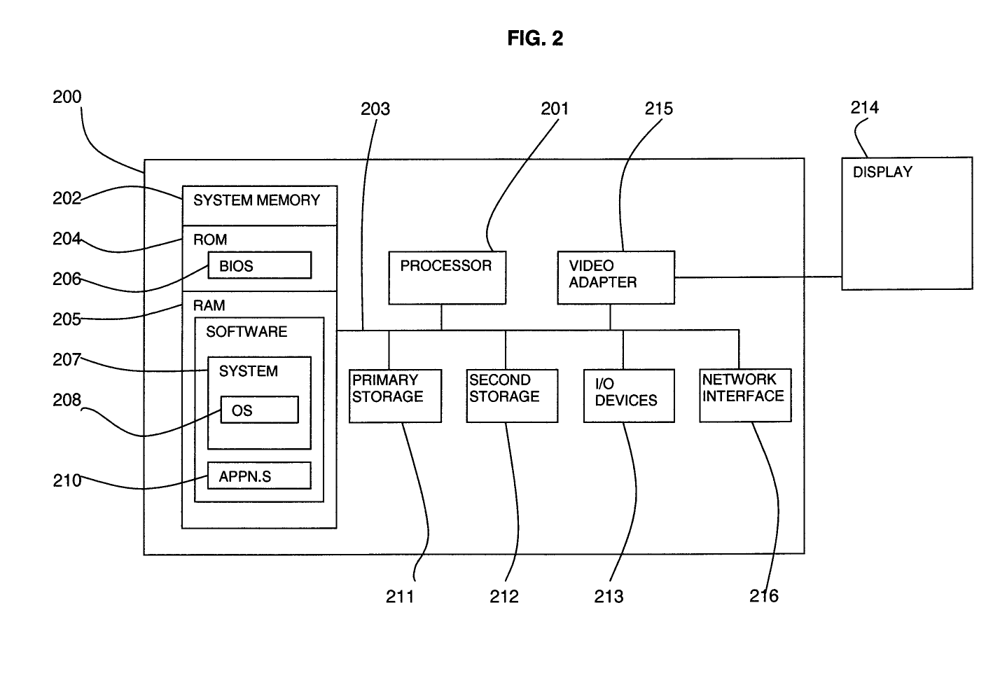

Referring to FIG. 2, an exemplary system for implementing the server and client and service systems includes a data processing system 200 suitable for storing and/or executing program code including at least one processor 201 coupled directly or indirectly to memory elements through a bus system 203. The memory elements can include local memory employed during actual execution of the program code, bulk storage, and cache memories, which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211, such as a magnetic hard disk drive, and secondary storage means 212, such as a magnetic disc drive and an optical disc drive. The drives and their associated computer-readable media provide non-volatile storage of computer-executable instructions, data structures, program modules and other data for the system 200. Software applications may be stored on the primary 211 and secondary 212 storage means, as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

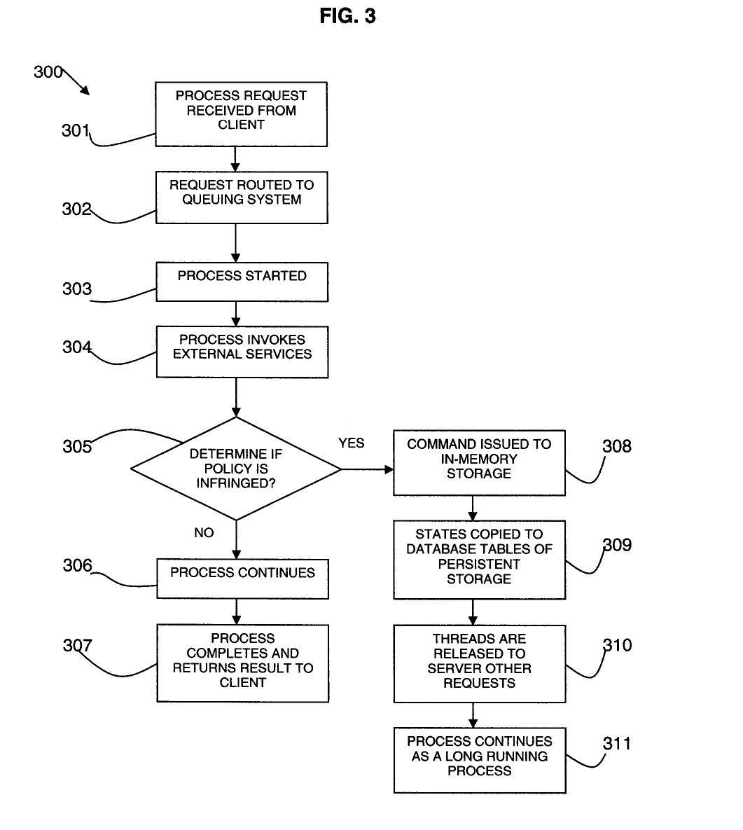

Referring to FIG. 3, a flow diagram 300 shows the described method. A process request is received 301 from a client. The request is routed 302 to a queuing system of a connection manager. The process is started 303 and invokes 304 external services. It is determined if a policy regarding the process is infringed 305. If no policy is infringed, the process continues 306 and completes 307 returning a result to the client without writing any data in persistent data storage.

If a policy is infringed, a command is issued 308 to the in-memory data store and the states are copied 309 to database tables of the persistent data storage. Threads are released 310 to serve other requests. The process then continues 311 as a long running process.

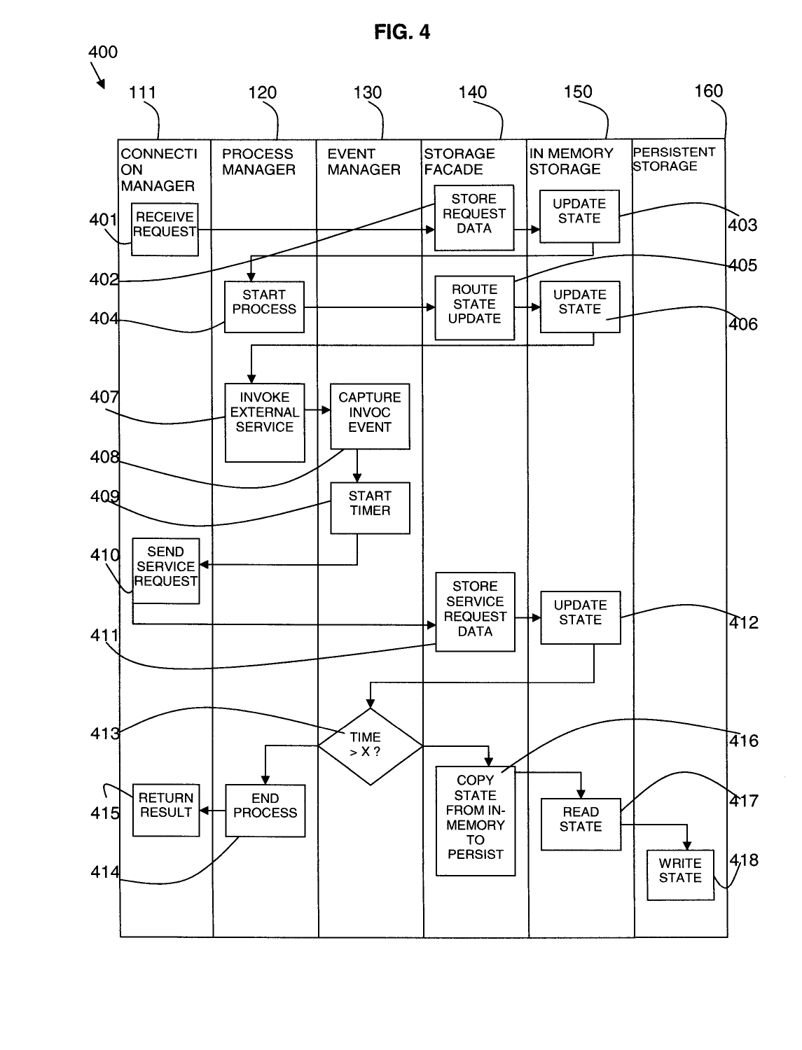

Referring to FIG. 4, an activity diagram 400 shows the activities carried out by the components showed in FIG. 1. The components are the connection manager 111, the process engine 120, the event manager 130, the storage façade 140, in-memory storage 150, and persistent storage 160.

The connection manager 111 receives a request 401 from a client, the request data is passed 402 to the storage façade 140, and the state updated 403 in-memory storage 150. The process starts 404 in the process engine 120 and the route state update 405 is passed to the storage façade 140 and the state updated 406 in-memory storage 150. The process invokes 407 an external service at the process engine 120. The event manager 130 captures 408 the invocation event and starts 409 a timer. The service request is sent 410 from the connection manager 111. The service request data is passed 411 to the storage façade 140 and the state updated 412 in-memory storage.

The event manager 130 determines 413 if the service request is taking more than a threshold time X. If not, the process continues 414 at the process engine 120 and ends by returning a result 415 to the connection manger 111. If the service request is taking more than a threshold time X, the state is copied 416 by the storage façade 140 from in-memory to persistent storage. The state is read 417 from in-memory storage 150 and written 418 to persistent storage.

The policies which may trigger the transfer from an uninterruptible process with in-memory storage to a long running process with persistent storage may be defined according to a processes requirements. Example policies are given below:

Policy 1: If the response time of any external service called by the process is more than a configurable threshold, the process will switch.

Policy 2: If the total duration of the process reaches a certain threshold, the process switches.

Policy 3: If during execution the process follows a certain execution path, the switch is triggered. For example, this may be an execution path that involves activities performed by human operators in which case the overall lifespan of the process is likely to be long and the process should be switched to long running.

The described method and system provide application of process service level management in Business Process Execution Language (BPEL) environments. Policies can be specified to dynamic service level adjustment rules.

The described method and system can be used in Enterprise Application Integration (EAI), which integrates enterprise computer applications. The lifecycle of processes performing application integration can have a high degree of variability: an integration process that completes in a few seconds in a best case scenario could last several hours in the case of an error scenario requiring human intervention. The described method and system will allow designers and developers to define a single process that can handle different scenarios.

An event manager for switching between an uninterruptible process and a long running process may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Aspects of the present invention may take the form of a computer program product embodied in one or more computer readable medium(s) having computer readable program code embodied thereon. Any combination of one or more computer readable medium(s) may be utilized. The computer readable medium may be a computer readable storage medium or a computer readable signal medium. A computer readable storage medium may be, for example, but not limited to, an electronic, magnetic, optical, electromagnetic, infrared, or semiconductor system, apparatus or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein; for example, in baseband or as part of a carrier wave. Such a propagated signal may take any of a variety of forms including, but not limited to, electro-magnetic, optical or any suitable combination thereof. A computer readable signal medium may be any computer readable medium that is not a computer readable storage medium and that can communicate, propagate or transport a program for use by or in connection with an instruction execution system, apparatus or device. Program code embodied in a computer readable signal medium may be transmitted using any appropriate medium including, but not limited to, wireless, wire line, optical fiber cable, RF, etc., or any suitable combination of the foregoing.

Computer program code for carrying out operations of the present invention may be written in any combination of one or more programming languages, including an object oriented programming language such as Java™, Smalltalk, C++ or the like, and conventional procedural programming languages, such as the “C” programming language or similar programming languages. (Java and all Java-based trademarks and logos are trademarks of Sun Microsystems, Inc., in the United States, other countries or both.) The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus, systems and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instructions which implement the function/act specified in the flowchart and/or block diagram block or blocks. The computer program instructions may also be loaded onto a computer or other programmable data processing apparatus to cause a series of operational steps to be performed in the computer or other programmable apparatus to produce a computer-implemented process, such that the instructions that execute in the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in a flowchart or block diagram may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of a block diagram and/or flowchart illustration, and combinations of blocks in block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
invoking an external service via a connection manager;
executing a process in a process engine, the process comprising an uninterruptible mode, a long running mode, a runtime metric and state information;
storing the state information in an in-memory storage;
comparing the runtime metric with a defined policy to determine if the process infringes the defined policy;
in response to a determination that the process infringes the defined policy, switching the process from the uninterruptible mode to the long running mode, and moving the state information from the in-memory storage to a persistent storage.

2. The method of claim 1, where the step of moving the state information from the in-memory storage to the persistent storage is performed by a storage mechanism and is transparent to the process engine and the connection manager.

3. The method of claim 1, where the defined policy comprises a response time of the external service exceeding a configurable threshold duration.

4. The method of claim 1, where the defined policy comprises a total duration of the process exceeding a configurable threshold duration.

5. The method of claim 1, where the defined policy comprises the process following a predetermined execution path.

6. The method of claim 1, where the step of moving the state information from the in-memory storage to the persistent storage comprises copying a hash map from the in-memory storage to a database table in the persistent storage.

7. A system, comprising:
a connection manager to invoke an external service;
a process engine to execute a process, where the process comprises an uninterruptible mode, a long running mode, a runtime metric and state information;
an in-memory storage to store the state information;
a persistent storage;
an event manager to compare the runtime metric with a defined policy to determine if the process infringes the defined policy; and
a storage controller, responsive to a determination that the process infringes the defined policy, to switch the process from the uninterruptible mode to the long running mode, and to move the state information from the in-memory storage to the persistent storage.

8. The system of claim 8, where the storage controller operation is transparent to the process engine and the connection manager.

9. The system of claim 8, where the defined policy comprises a response time of the external service exceeding a configurable threshold duration.

10. The system of claim 8, where the defined policy comprises a total duration of the process exceeding a configurable threshold duration.

11. The system of claim 8, where the defined policy comprises the process following a predetermined execution path.

12. The system of claim 8, where the storage controller moves the state information from a hash map in the in-memory storage to a database table in the persistent storage.

13. A computer program product comprising a computer readable storage medium having computer readable program code embodied therewith, the computer readable program code comprising:
computer readable program code configured to invoke an external service via a connection manager;
computer readable program code configured to execute a process in a process engine, the process comprising an uninterruptible mode, a long running mode, a runtime metric and state information;
computer readable program code configured to store the state information in an in-memory storage;
computer readable program code configured to compare the runtime metric with a defined policy to determine if the process infringes the defined policy;
computer readable program code configured to switch the process from the uninterruptible mode to the long running mode, and to move the state information from the in-memory storage to a persistent storage in response to a determination that the process infringes the defined policy.

14. The computer program product of claim 13, further comprising computer readable program code configured to implement a storage mechanism that is transparent to the process engine and the connection manager.

15. The computer program product of claim 13, where the defined policy comprises a response time of the external service exceeding a configurable threshold duration.

16. The computer program product of claim 13, where the defined policy comprises a total duration of the process exceeding a configurable threshold duration.

17. The computer program product of claim 13, where the defined policy comprises the process following a predetermined execution path.

18. The computer program product of claim 13, further comprising computer readable program code configured to copy a hash map from the in-memory storage to a database table in the persistent storage.
